(19) United States
(12) Patent Application Publication
(10) Pub. No.: US 2010/0065210 A1
(43) Pub. Date: Mar. 18, 2010

(54) FLOWABLE NON-SAGGING ADHESIVE COMPOSITIONS

(75) Inventors: Charles F. Schuft, Boxborough, MA (US); James Murray, Newmarket, NH (US)

Correspondence Address: Loctite Corporation, One Henkel Way, Rocky Hill, CT, 06067, US

(73) Assignee: HENKEL CORPORATION, ROCKY HILL, CT (US)

(21) Appl. No.: 12/447,612

(22) PCT Filed: Nov. 2, 2007
(86) PCT No.: PCT/US07/23141

§ 371 Date: Apr. 28, 2009

Related U.S. Application Data
(60) Provisional application No. 60/856,708, filed on Nov. 3, 2006.

(51) Int. Cl. C09J 163/10; C08F 283/00

(52) U.S. Cl. 156/330; 525/404

(57) ABSTRACT

This invention provides an acrylic epoxy adhesive as a two part composition, wherein each part is of suitable viscosity for use in pumping apparatus, but after mixing, the composition increases in viscosity, so that it will not sag, drip, or migrate after application to a surface during the open time. This effect is achieved with a reactive acid component that gels on mixing with the epoxy portion of the composition. Also provided is a method of preparing the adhesive composition, and method of using the composition to form laminated materials.

### FIELD OF THE INVENTION

The present invention provides non-sagging, speed controlled adhesive compositions which include a first part containing an acrylic component and a second part containing an epoxy resin component. Also provided by the present invention are methods of making and using the compositions.

### BRIEF DESCRIPTION OF RELATED TECHNOLOGY

Adhesives and sealants used in the fabrication of laminates employed in large machinery, such as wind energy blades, require special qualities, including the ability to resist sagging, dripping, and migration of the adhesive during the fabrication process. Also important is adjustable speed control, from short “open time” (i.e., the elapsed time between the application of the adhesive to curing) for fast bonding applications, to very long “open time” to allow for the necessary amounts of adhesive to be applied over large bond areas before mating the parts. For large scale application of adhesives, the adhesive should also be sufficiently flowable to be handled by pumping apparatus during the fabrication process. Desirable adhesives possessing these characteristics employ an acrylate component. Several such adhesive compositions are known in the art.

One approach to these adhesives are (meth)acrylates with reactive crosslinkers, such as epoxides. Acrylic-based adhesive compositions are well known. See e.g., U.S. Pat. No. 4,536,546 (Briggs). While adhesives based on this technology appear to have been sold under the tradenames PLEXUS MA 300 and 310 by Illinois Tool Works Inc., Chicago, Ill., they can exhibit an obnoxious odor and they are toxic to handle, which are significant drawbacks to their use. In addition, these adhesives are flammable, and have a low flash point, causing enhanced safety concerns to distributors, transporters and end users.

Two-part epoxy resin compositions are also known, where one of the parts includes an acrylic-based adhesive. For instance, U.S. Pat. No. 4,426,243 (Briggs) describes an adhesive composition that is prepared from two different adhesive materials, one being an epoxy resin and the other an acrylate-based adhesive, being chemically bonded together by a bifunctional component having as one of its functional groups an epoxy and as the other an acrylate. See also U.K. Patent No. GB 2166447B.

In addition, International Publication No. PCT/US98/12260 discloses a polymerizable composition for use with an aerobic initiator that is based on ethylenically unsaturated monomers, such as (meth)acrylates, which have a boiling point of at least 160° C., an average monomer fluorophilicity of at about 3.25, and polymers thereof have a glass transition state of at least −20° C. These compositions are said to be useful in bonding low surface energy substrates.

However, existing compositions do not possess the desired balance between flowability and sag, drip, and migration resistant properties, with open time speed control, including both short and long open time adjustability. Accordingly, there is a need for a sag-resistant composition which is inexpensive, speed controlled, and possesses low surface tack after cure.

### SUMMARY OF THE INVENTION

In one aspect, the present invention provides a sag-resistant composition including: (a) a first part which includes: (i) a (meth)acrylic component, (ii) an amine catalyst; (iii) an optional second catalyst; (iv) a reactive acid component, and (v) a free-radical inhibitor; and (b) a second part which includes: (i) a resin component which includes epoxy groups, (ii) a peroxide; and (iii) a metal compound which complexes with the strong acid component and which is substantially non-reactive with the peroxide. In this invention, the first and second parts are of sufficiently low viscosity to be easily dispensed with a pumping apparatus. To form the adhesive of this invention, the first and second parts are mixed, and immediately after mixing, the mixture is of a higher viscosity, such that the adhesive does not sag, drip, or migrate, after application to a surface within the open time of the mixture, and the mixed first and second parts cure. By the term “open time” is meant the elapsed time between the mixture of the adhesive to the curing.

In the composition of the foregoing paragraph, the reactive acid component of the first part causes a substantial increase in the viscosity of the mixed parts, because it forms a thick gel on mixing with the epoxy resin.

Additionally, the open time of the composition can be adjusted by controlling the ratio of the metal compound in the second part to the amount of reactive acid component in the first part.

In another aspect, the present invention provides a method of preparing a sag-resistant adhesive composition, using the composition just disclosed.

In another aspect, the present invention provides a method of bonding two surfaces, using the composition just disclosed.

### DETAILED DESCRIPTION OF THE INVENTION

The present invention provides for adhesive and sealant compositions, which have desirable properties for use as an adhesive in fabricating large laminates, where the size of the application requires the use of pumping equipment to apply the adhesive efficiently and uniformly, and where the laminates are manipulated during the fabrication process, so that the adhesive must not sag or migrate after application and prior to curing. Accordingly, this invention is a thixotropic, two part thermoset adhesive system, wherein each individual part is sufficiently fluid to be dispensed with pumping apparatus. On mixing of the two parts, the viscosity of the mixed material rapidly increases substantially, so that the mixed parts do not sag, drip, or migrate prior to curing, during the open time of the adhesive. By the term “does not sag, drip, or migrate,” is meant that the mixed adhesive configured in a sufficiently large bead size for the application, prior to the cured state, will not significantly move under its own weight, relative to a surface to which it is applied, even if the surface is moved, tilted, or turned upside down.

The adhesives and sealants of this invention are useful for laminating polymeric materials for use in large scale industrial equipment. A suitable application for this invention is in the fabrication of propeller blades for wind powered energy generating equipment, i.e., windmills. Alternative utilities for this invention include other lightweight laminates fabricated into special shapes, such as airfoils for aircraft surfaces, parts for marine craft, such as boat hulls, and automotive or truck body panels.

For example, propeller blades employed in modern windmills are up to 60 meters long and may be manufactured by lamination of polymeric materials. In the process of lamination, large beads of the adhesive, as much as one to six inches in diameter, are dispensed on sheets of a polymer sheet material and multiple sheets are joined to form a laminate in the desired shape. The adhesive composition used must be capable of being pumped because of the large quantities involved. Therefore, the adhesives must have a viscosity sufficient to allow pumping, but when applied on the surface of a polymer sheet, the mixture must not be so fluid as to sag, drip, or migrate, because during fabrication, a sheet with a bead of adhesive applied thereto may be tilted, rotated, or turned upside down as it is laminated to mating polymer sheets.

Accordingly, this invention provides a sag-resistant thermoset composition including: (a) a first part which includes: (i) an acrylic component, (ii) an amine catalyst; (iii) an optional second catalyst; (iv) a reactive acid component, and (v) a free-radical inhibitor; and (b) a second part which includes: (i) a resin component which includes epoxy groups, (ii) a peroxide; and (iii) a metal compound which complexes with the phosphate ester and which is substantially non-reactive with the peroxide. During the manufacture of compositions of this invention, the combination of parts (a) and (b) results in a thermoset polymer composition that cures and forms a material suitable for use in the fabrication of laminates. Thus, the mixture of parts (a) and (b) can be applied to a surface to be laminated, and that surface can be mated to a second surface to form the laminate. After curing, the composition of this invention forms a firm bond between the two surfaces.

In the present invention, the individual compositions of parts (a) and (b) must be pumpable, yet when mixed and applied, must have a suitable viscosity to prevent sagging, dripping, or migration prior to the curing of the thermoset. This is accomplished in this invention by the addition of a reactive acid component, such as a phosphate acid ester, to part (a) of the composition. After mixing with part (b), the reactive acid component complexes into a three-dimensional matrix with the epoxy resin or an acid reactive crosslinker in part (b), to form a thick gel that is sufficiently sticky to remain firmly affixed to a surface to which it is applied. The thickened mixture will not sag, drip, or migrate under its own weight during the open time of the adhesive. The gelling occurs very quickly and imparts the anti-sagging characteristics as the composition is mixed and applied directly during fabrication.

However, the reactive acid component also complexes with the amine catalyst, or the optional second catalyst, and this retards the rate of curing, giving a long open time. In fact, a longer than desired open time may occur. Accordingly, in order to balance the sag resistant properties with the open time of the adhesive of this invention, a basic metal compound, such as bismuth subsalicylate, is added to part (b), which is substantially non-reactive with the peroxide component of part (b). The bismuth serves to complex the strong acid component, and free some of the amine, which accelerates the cure rate. Thus, the ratio of the basic metal compound in part (b) to the strong acid in part (a) controls the reaction rate, by controlling the availability of the catalyst.

Part (A)

(Meth)Acrylic Resin Components

The acrylic component of the present invention may be any suitable material which contains at least one group having the following formula:

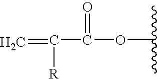

wherein R is a member selected from the group consisting of H, halogen, and C₁ to C₁₀) hydrocarbyl. Advantageously, the group is a (meth)acryloxy group. The term “(meth)acryloxy” is intended to refer to both acrylate and methacrylate, in which R is H or methyl, respectively. The useful amount of acrylic resin component(s) typically range(s) from about 20 percent by weight to about 80 percent by weight of the total composition. Desirably, the present inventive compositions contain from about 50 percent by weight to about 70 percent by weight of acrylic resin.

The acrylic material may be present in the form of a polymer, a monomer, or a combination thereof. When present in the form of a polymer, the acrylic material may be a polymer chain to which is attached at least one of the above-indicated groups. The groups may be located at a pendant or a terminal position of the backbone, or a combination thereof. Advantageously, at least two such groups may be present, and may be located at terminal positions. The acrylic material polymer chain of the material may be polyvinyl, polyether, polyester, polyurethane, polyamide, epoxy, vinyl ester, phenolic, amino resin, oil based, and the like, as is well known to those skilled in the art, or random or block combinations thereof.

Advantageously, the polymer chain of the material may be formed by polymerization of vinyl monomers. Illustrative examples of such vinyl monomers are methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate and ethoxylated bisphenol A di(meth)acrylate. These monomers may be used each alone or a plurality of them may be copolymerized.

Amines

The present inventive compositions include at least one amine that acts as a catalyst by accelerating or otherwise promoting curing of the present inventive compositions. The amines of the present invention are either tertiary or sterically hindered. Suitable amines include, for example, tertiary amines represented by the formula NR₃, wherein R is selected from the group consisting of alkyl, aryl, alkaryl, or aralkyl radicals, including C₁₋₁₀ alkyl, C₆₋₁₈ aryl, C₇₋₁₅ alkaryl, and C₇₋₁₅ aralkyl radicals. Suitable hindered amines also include primary or secondary amines, such as HNR₂ or H₂NR, where R is a C₄₋₁₀ alkyl. For example, alkyl groups such as tertiary butyl, or neopentyl, sterically shield the hydrogen bound to the nitrogen atom, and are suitable substituents in this component of the present invention. For either tertiary amines or secondary amines, the R groups may be linked so that the nitrogen is embedded within a cyclic structure.

Particularly useful amines for inclusion in the present inventive compositions include, for example, 1,8-diazabicyclo(5.4.0)undec-7-ene (DBL, 1,4-diazabicyclo(2.2.2)octane (DABCO), triethylamine, and substituted guanidines, such as tetramethylguanidine (TMG), dimethyl-p-toluidine (DMPT), dimethyl aniline, dihydroxyethyl aniline, dihydroxy ethyl p-toluidine, dimethyl-o-toluidine, dialkyl aniline, dialkyl toluidine and the like, acyl thiourea, benzoyl-thiourea, and aryl-thiourea.

The amine can be present in an amount from about 0.01 percent by weight to about 5 percent by weight. Desirably, the amine is present in an amount from about 0.05 percent by weight to about 2 percent by weight. More desirably, the amine is present in amount from about 0.3 percent by weight to about 0.7 percent by weight.

Reactive Acid Component

The compositions of the present invention include an acid or acid ester which increases the viscosity of the mixture after part (a) and part (b) are combined. Suitable acids or acid esters include phosphoric acid or derivatives, phosphate acid esters, and sulfonic acids or derivatives. A preferred reactive acid component is a phosphate acid ester.

The reactive acid component also modulates and decelerates the curing time of the thermoset composition. The amine component is necessary to cure the thermoset, but without a phosphate ester component, the amine induced curing process is generally too rapid for very large parts or laminates, making fabrication of the laminate too difficult. Additionally, excessively fast curing can cause trouble during curing, such as excessive heat from the exothermic curing reaction, and give inconsistent or uneven curing, and the resultant product may have undesirable physical characteristics, such as bubbling, brittleness, or less tensile strength than can be achieved when the curing is at a more measured rate.

To show that a phosphate ester slows down the cure time, Tables 2 to 5, below, show that without an amine (i.e., DMPT) or phosphate ester component (i.e., T-MULZ® 1228), the thermoset reaction does not cure at all. With DMPT, the cure took place in 28 minutes. The addition of the phosphate ester retards the cure. Ideally, the thermoset should cure in 50 to 200 minutes. Thus, the rate of curing can be adjusted by tuning the amount of phosphate acid ester, amine, optional secondary catalyst, and metal component in part (b).

Suitable phosphate esters for use in the composition of the present invention include those represented by the formula:

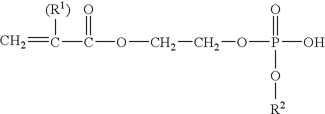

where R¹ is H or CH₃, and R² is H, or a radical represented by the structure:

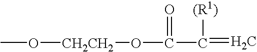

where R¹ is H or CH₃. A particularly useful phosphate ester for use in the present invention is hydroxyl ethyl methacrylate (HEMA) phosphate ester, which is sold under the tradename T-MULZ® 1228, available from Harcross Chemicals, Kansas City, Kans. Also included are structures with at least one strong acid “active hydrogen” group, or with at least one phosphonic acid active hydrogen group (R₁R₂POOH), such as hydroxyl ethyl diphosphonic acid, phosphonic acid, and derivatives, or oligomeric or polymeric structures with phosphonic acid functionality or similar acid strength functionality.

In the present invention, the reactive acid or the phosphate ester component is present from about 0.25 percent by weight to about 10 percent by weight of the composition. Desirably, the phosphate ester is present from about 1.0 to 4.0 percent by weight of the composition.

Free Radical Inhibitors

The part (a) composition of this invention also requires a free radical polymerization inhibitor, which prevents the part (a) from reacting prematurely prior to mixing. The use of a free radical inhibitor allows the part (a) composition to be blended and shipped in drums, and remain stable for a period of months prior to use.

The free radical inhibitor component also prevents the other components of part (a) from reacting with each other. This is critical, because both parts (a) and (b) may be produced in large quantities, up to 10,000 kg batches, and stored and shipped in containers such as drums, for use in fabrication of laminates at customer sites. It is imperative that the products survive shipping and arrive ready for mixing. Moreover, as the reaction is exothermic, premature reaction, such as during transit, could be a safety hazard.

The stability of the part (a) composition was measured in accelerated conditions at 82° C. In this test, the time for the part (a) composition to harden is measured. Longer times to harden are more desirable when large parts are being bonded. A minimum survival time of 12 hours before reaction or hardening was required in this test. In addition, the accelerated conditions give an indication of suitability of the composition for passing the DOT “Self Accelerating Decomposition Temperature” (SADT) test, pertaining to safety in shipping. See 49 CFR 173.124. Table 1 shows the stability of various mixtures at 82° C.

TABLE 1
Stability of Part (a) with methylmethacrylate
under accelerated conditions, 82° C.

| # | HQ, % | DMPT, % | T-MULZ ® 1228, % | Life (hrs) |
|---|---|---|---|---|
| 1 | 0 | 0.5 | 2.5 | 2 |
| 2 | 0.25 | 0.5 | 2.5 | 15 |
| 3 | 0.5 | 0.5 | 2.5 | >19 |
| 4 | 0.75 | 0.5 | 2.5 | >19 |
| 5 | 0 | 0.98 | 3.94 | 1 |
| 6 | 0.25 | 0.98 | 3.54 | 11 |
| 7 | 0.5 | 0.98 | 3.54 | 13 |
| 8 | 0.75 | 0.98 | 3.54 | 15 |

HQ = hydroquinone
DMPT = dimethyl-p-toluidine

For example, in experiment 3, a methylmethacrylate composition with 0.5% hydroquinone (HQ), 0.5% DMPT (an amine base), and 2.5% T-MULZ® 1228 (a phosphate acid ester), did not self react or harden after 19 hours under accelerated stability at 82° C. By contrast, in experiment 1, without any HQ in the composition, the composition hardened in 2 hours. As can be seen, the effects of 0.25% HQ were dramatic in increasing the shelf life of the part (a) methylmethacrylate composition.

Numerous suitable free-radical polymerization inhibitors are known in the art, and include quinones, hydroquinones, hydroxylamines, nitroxyl compounds, phenols, amines, arylamines, quinolines, phenothiazines, and the like. Particularly useful free radical inhibitors include hydroquinone, tertiary butylhydroquinone (TBHQ), hydroxyethylhydroquinone, phenothiazine, and “Naugard®-R” blend of N-alkyl substituted p-phenylenediamines (from Crompton Corp.). One or more individual free radical inhibitor components may be combined in this invention.

Additional Catalysts

An additional catalyst may optionally be included in the part (a) composition of this invention. The polymerization inhibitors decelerate the thermoset cure speed, but we found that certain additional basic catalysts, added to the part (a) of the composition, can accelerate the thermoset cure time without adversely affecting the shelf life. These catalysts were shown to affect the phosphate acid ester component, and had no effect in the absence of the phosphate acid ester. See Tables 2 and 3.

TABLE 2
Time to cure, 0.5% DMPT and 4.0% T-MULZ ® 1228

| Expt. No. | Free Radical Inhibitor Additive, 1.0% | Time to Cure (min) |
|---|---|---|
| 1 | Control (no additive) | 974 |
| 2 | Pyridine N-oxide | 187 |
| 3 | 8-hydroxyquinoline | 107 |
| 4 | Barium hydroxide | 72 |
| 5 | Quinoline | 91 |

DMPT = dimethyl-p-toludine

TABLE 3
Control Study. Affect of Free Radical additives
without T-MULZ ® 1228 or DMPT

| Expt. No. | Free Radical Inhibitor Additive, 1.0% | Time to Cure (min) |
|---|---|---|
| 1 | DMPT 0.5% (control) | 28 |
| 2 | Pyridine N-oxide | >1000 |
| 3 | 8-hydroxyquinoline | >1000 |
| 4 | Barium hydroxide | >1000 |
| 5 | Quinoline | >1000 |

Table 2 demonstrates that after mixing parts (a) and (b), if part (a) contained no additional catalyst, the time to cure was 974 minutes (experiment 1). The addition of various secondary basic catalysts, at 1% by weight (e.g., 1% quinoline in experiment 5) to part (a) substantially decreased the cure time after mixing, from 974 minutes to 91 minutes. Table 3 shows that the free radical inhibitors were not capable of catalyzing the curing directly. Without T-MULZ® 1228 or DMPT, but with free radical inhibitors added to part (a), the thermoset did not cure, at least within 1000 minutes of monitoring (experiments 2-5). As a control, the addition of DMPT (experiment 1) caused a rapid cure, in just 28 minutes.

Suitable secondary catalysts are bases, and include pyridine N-oxide, quinoline, 8-hydroxyquinoline, benzyltrimethylammonium chloride, and barium hydroxide. The secondary catalyst, if present, can be used in an amount of about 0.005 to 0.4 percent by weight of the part (a) composition. Desirably, the secondary catalyst, if present, is used in an amount of about 0.01 to 0.2 percent by weight of part (a). As two or more secondary catalysts may be present in compositions of this invention, they may be present in different weights.

Other Additives

In addition to the aforementioned components, part (a) may contain additional additives, such as fillers, lubricants, thickeners, and coloring agents. A particular purpose of the fillers is to provide bulk in the finished product without sacrificing strength of the adhesive, and can be selected from high or low density fillers. Of particular advantage are the low density fillers, with which the resulting final product is therefore lower in density than a product without the filler, yet has essentially the same strength characteristics as if the filler was not present.

Part (B)

Epoxy Resins

The second component of the thermoset polymer of the present invention, part (b), is a resin component employing reactive epoxy groups. The resin may include cycloaliphatic epoxides, epoxy novolac resins, bisphenol-A epoxy resins, bisphenol-F epoxy resins, bisphenol-A epichlorohydrin based epoxy resin, alkyl epoxides, limonene dioxides, and polyepoxides.

A desirable resin component is a cycloaliphatic epoxide sold by Dow Chemical under the brand name “Cyracure UVR-6110.” UVR-6110 has the following structure:

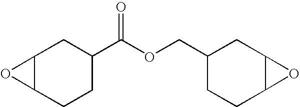

Another suitable resin component is a bisphenol based liquid epoxy resin, such as those sold under the brand names “D.E.R. ™” by Dow Chemical. For description of these epoxy resins, see http://epoxy.dow.com/epoxy/products/prod/liquid.htm. Examples of “D.E.R.”products that are suitable for this invention include D.E.R. 332, diglycidyl ether of bisphenol-A; D.E.R 330, low viscosity, undiluted, bisphenol-A liquid epoxy resin; D.E.R. 383, low viscosity, undiluted, bisphenol-A liquid epoxy resin; D.E.R 354, standard, bisphenol-F based liquid epoxy resin; D.E.R 351, low viscosity, liquid bisphenol-AIF resin blend; D.E.R. 352, low viscosity, liquid bisphenol-AIF resin blend; D.E.R. 324, aliphatic glycidyl ether reactive diluent, modified liquid epoxy resin; D.E.R. 323, aliphatic glycidyl ether reactive diluent, modified liquid epoxy resin; D.E.R. 325, aliphatic glycidyl ether reactive diluent, modified liquid epoxy resin; and D.E.R. 353, aliphatic glycidyl ether reactive diluent, modified liquid epoxy resin. A different brand of a bisphenol based liquid epoxy resin suitable for use in this invention is “EPON™ Resin 828,” derived from bisphenol A and epichlorohydrin, and commercially available from Hexion Specialty Chemicals. See http://www.hexionchem.com/pds/E/EPON™ Resin 828.pdf.

Another suitable resin component is an epoxy novolac resin, which are products of epichlorohydrin and phenol-formaldehyde novolac, and sold under the brand names “D.E.N.™” by Dow chemical. For a description of these epoxy resins, see http://epoxy.dow.comlepoxy/products/prod/nov.htm. Examples of “D.E.N.” products that are suitable for this invention include D.E.N. 431, low viscosity semi-solid epoxy novolac resin; and D.E.N. 438, Semi-solid epoxy novolac resin.

Other epoxy resins suitable for use in the compositions of the present invention include polyepoxides curable by elevated temperature. Examples of these polyepoxides include polyglycidyl and poly(β-methylglycidyl)ethers obtainable by reaction of a compound containing at least two free alcoholic hydroxyl and/or phenolic hydroxyl groups per molecule with the appropriate epichlorohydrin under alkaline conditions or, alternatively, in the presence of an acidic catalyst and subsequent treatment with alkali. These ethers may be made from acyclic alcohols such as ethylene glycol, diethylene glycol, and higher poly(oxyethylene) glycols, propane-1,2-diol and poly(oxypropylene) glycols, propane-1,3-diol, butane-1,4-diol, poly(oxytetramethylene) glycols, pentane-1,5-diol, hexane-2,4,6-triol, glycerol, 1,1,1-trimethylolpropane, pentaerythritol, sorbitol, and poly(epichlorohydrin); from cycloaliphatic alcohols such as resorcinol, quinitol, bis(4-hydroxycyclohexyl)methane, 2,2-bis(4-hydroxycyclohexyl)propane, and 1,1-bis(hydroxymethyl)-cyclohex-3-ene; and from alcohols having aromatic nuclei, such as N,N-bis(2-hydroxyethyl)aniline and p,p′-bis(2-hydroxyethylamino)diphenylmethane. Or they may be made from mononuclear phenols, such as resorcinol and hydroquinone, and from polynuclear phenols, such as bis(4-hydroxyphenyl)methane, 4,4′-dihydroxydiphenyl, bis(4-hydroxyphenyl) sulphone, 1,1,2,2-tetrabis(4-hydroxyphenyl)ethane, 2,2,-bis(4-hydroxyphenyl)propane (otherwise known as bisphenol A), 2,2-bis(3,5-dibromo-4-hydroxyphenyl)propane, and novolaks formed from aldehydes such as formaldehyde, acetaldehyde, choral, and furfuraldehyde, with phenols such as phenol itself, and phenols substituted in the ring by chlorine atoms or by alkyl groups each containing up to nine carbon atoms, such as 4-chlorophenol, 2-methylphenol, and 4-t-butylphenol.

Poly(N-glycidyl) compounds include, for example, those obtained by dehydro chlorination of the reaction products of epichlorohydrin with amines containing at least two amino-hydrogen atoms, such as aniline, n-butylamine, bis(4-aminophenyl)methane, and bis(4-methylaminophenyl)methane; triglycidyl isocyanurate; and N,N′-diglycidyl derivatives of cyclic alkylene ureas, such as ethyleneurea and 1,3-propyleneureas, and of hydantoins such as 5,5-dimethylhydantoin.

Epoxide resins having the 1,2-epoxide groups attached to different kinds of hetero atoms may be employed, e.g., the N,N,O-triglycidyl derivative of 4-aminophenol, the glycidyl ether-glycidyl ester of salicylic acid, N-glycidyl-N′-(2-glycidyloxypropyl)-5,5-dimethylhydantoin, and 2-glycydyloxy-1,3-bis(5,5-dimethyl-1-glycidylhydantoin-3-yl)propane.

Epoxides derived from oils, such as epoxidized soybean oil, epoxidized castor oil, and the like are also suitable. Epoxides derived from or capable of being derived from the per-acid oxidation of unsaturation are also suitable, including epoxidized liquid rubber.

Peroxides

The part (b) of the present invention requires a peroxide component, which reacts with the acrylate component of part (a) and activates it for curing. The peroxide is desirably selected from cumene hydroperoxide; methyl ethyl ketone peroxide; benzoyl peroxide; acetyl peroxide; 2,5-dimethylhexane-2,5-dihydroperoxide; tert-butyl peroxybenzoate; di-tert-butyl perphthalate; dicumyl peroxide; 2,5-dimethyl-2,5-bix(tert-b-utylperoxide)hexane; 2,5-dimethyl-2,5-bis(tert-butylperoxy)hexyne; bix(tert-butylperoxyisopropyl)benzene; ditert-butyl peroxide; 1,1-di(tert-amylperoxy)-cyclohexane; 1,1-di-(tert-butylperoxy)-3,3,5-trim-ethylcyclohexane; 1,1-di-(tert-butylperoxy)-cyclohexane; 2-di-(tert-butylperoxy)butane; n-butyl-4,4-di(tert-butylperoxy)valerate; ethyl-3,3-di-(tert-amylperoxy)butyrate; ethyl-3,3-di(tert-butylperoxy)-butyrate; t-butyl peroxy-neodecanoate; di-(4-5-butyl-cyclohexyl)-peroxydicar-bonate; lauryl peroxyde; 2,5-dimethyl-2,5-bis(2-ethyl-hexanoyl peroxy) hexane; t-amyl peroxy-2-ethylhexanoate; 2,2′-azobis(2-methyl-propionitrile); 2,2′-azobis(2,4-methlbutanenitrile). Additionally, one or more of the peroxides from this list may be combined.

Basic Metal Additives

The part (b) of the present invention also contains a basic material or basic metal component, which neutralizes the strong acid component, i.e., the phosphate acid ester, of part (a) during the curing process. Alternatively, the base or basic metal complexes with, or chelates the acid component during curing. This base component accelerates the cure speed, and shortens the open time of the adhesive. The basic component must be substantially non-reactive with the peroxide component of part (b). This metallic component is desirably selected from zinc complexes, or bismuth complexes, for example bismuth subsalicylate, bismuth (III) oxide, bismuth aluminate, bismuth subcarbonate, “BiCAT Z®,” (a zinc carboxylate mixture from Shepard Chemical Co., Norwood, Ohio.), “BiCAT V®,” (bismuth carboxylate mixture from Shepard Chemical Co.), or “BiCAT 8®,” (bismuth/zinc neodecanoate mixture from Shepard Chemical Co.). Additionally, one or more of these basic metal complexes may be combined.

The basic metal component of part (b) has no independent catalytic effect, as shown by the data in Table 4 and Table 5.

TABLE 4
Effect of bismuth additives on curing time, 0.5%
DMPT and 4.0% T-MULZ ® 1228.

| Expt No. | Additive 0.5% | Time to cure (min) |
|---|---|---|
| 1 | None (control) | 974 |
| 2 | Bismuth salicylate | 343 |
| 3 | Bismuth aluminate | 757 |

TABLE 5
Control Study. Affect of base metal additives
without T-MULZ ® 1228 or DMPT

| Expt No. | Additive, 0.5% | Time to cure (min) |
|---|---|---|
| 1 | DMPT, 0.5% (control) | 28 |
| 2 | Bismuth salicylate | >1000 |
| 3 | Bismuth aluminate | >1000 |

Table 4 shows that in the thermoset reaction without a base metal component (experiment 1), the time to cure was 974 minutes, but with various bismuth salts, the time to cure was substantially reduced. Table 5 shows that the bismuth salts have no independent catalytic activity, but rather only affect the T-MULZ® 1228 component. With no T-MULZ® 1228 and 0.5% DMPT (experiment 1), the cure proceeds very quickly. Without either T-MULZ® 1228 or DMPT, the thermoset does not cure on the addition of bismuth salts (experiments 2-3), at least within 1000 minutes.

The base metal component can be present in an amount from about 1.0 percent by weight to about 10 percent by weight. Desirably, the base metal is present in an amount from about 3 percent by weight to about 7 percent by weight.

Packaging and Mixing. Each of parts (a) and (b) are advantageously packaged in industrial grade shipping containers, such as bottles, cans, tubes, or drums. In particular, for large scale applications, polyethylene or stainless steel drums, up to 55 gallons, are useful.

Parts (a) and (b) are mixed in a ratio of about 3 to 50 parts (a) to one part (b). Preferably, the ratio of parts (a) to (b) is about 5 to 20 parts (a) to one part (b).

The parts (a) and (b) are each of a viscosity to render them pumpable using suitable apparatus, particularly a meter mix pump. Typically, meter mixing devices involve a ram press, wherein a piston plate is depressed in a drum filled with fluid, forcing the fluid out through a suitable passage. An alternative meter mixing device pressurizes a fluid filled drum, forcing the fluid out through a suitable passage.

The pumpability of the compositions of the present invention depend on a suitable viscosity of the parts (a) and (b), which must be independently pumped to the dispensing device, where the two parts are mixed and applied to a surface to be bonded. Accordingly, part (a) has a viscosity of between 5,000 and 1,000,000 cP as measured on a Brookfield viscometer. Preferably, the viscosity of part (a) is between 75,000 and 175,000 cP. The viscosity of part (b) is between 1000 and 1,000,000 cP, preferably between 15,000 cP and 50,000 cP.

The mixing of the two parts can employ a mixing nozzle, which has fluid inputs for the two components, performs a suitable mixing operation, and dispenses the adhesive mixture directly onto the surface to be bonded. An example of a commercially available mixing and dispensing device is “MIXPAC®,” available from ConProTec, Salem, N.H. The two parts can also be mixed manually in a bowl, bucket, or the like, but the operator needs to ensure that the mixing is thorough. As an aid to ensuring that mixing is complete, each part can be formulated with a dye, so that after mixing, a third color is formed. For example, one part may have a yellow dye, the other part may have a blue dye, so that after mixing, the complete adhesive composition will be green.

The compositions of this invention are excellent adhesives and sealants. On application to a surface, such as a sheet of fabric that can be incorporated into a laminated material, the adhesive composition of this invention will not substantially sag, drip, or migrate under its own weight during the open time as the surface is manipulated in the fabrication process. In the preparation of laminated materials, a second surface will be mated with the first surface and the two surfaces will be bonded together as the adhesive cures. A further advantage to the adhesives of this invention is that no surface preparation is required to bond clean substrates.

By the term “curing” is meant that the chemical reaction converting the fluid mix to the solid bond of this invention. The curing process of acrylic-epoxy adhesives is well known in the art. See for example, Briggs, U.S. Pat. No. 4,426,243. The curing process is a chemical reaction between the acrylate and epoxy based polymers, to form an adhesive acrylic-epoxy adhesive.

The curing process of this composition is exothermic, and may reach a temperature of approximately 120° C. or so, when a large bead of adhesive is used. After mixing, the adhesive compositions of this invention cure in about 15 to 1000 minutes. Desirably, the adhesive composition will cure in about 100 to 150 minutes.

### Example 1

### Part (a) Composition

A 50 L vessel was charged with 27.3 kg methylmethacrylate, 1.0 kg methacrylic acid, 45 g of Sodium EDTA salt, 5 g of methyl ether of hydroquinone, and 45 g of phenothiazine. The mixture was blended with an auger at 1000 rpm. After the mix was uniform, approx. 30-60 min, 5.06 kg of powdered styrene-butadiene-styrene block copolymer, and 0.171 melted paraffin wax was added. After additional blending, 0.225 kg DMPT and 0.90 kg T-MULZ® 1228 were added and blended into the mixture. Next, Cabosil® M-5 Silica, 0.410 kg, and 6.156 kg 3M G-3125 hollow ceramic microspheres were blended into the mixture, and the final product was packed into 490 mL nylon cartridges.

The viscosity of the part (a) was 100,000-160,000 cP measured in a Brookfield viscometer at 20 rpm.

### Part (b) Composition

A 10 L vessel was charged with 3.22 kg EPON® 828 and 0.3 kg bismuth subsalicylate. The mixture was blended with an auger for 30 min at 1000 rpm. Benzoyl peroxide (Benox® B-50, a paste dispersion from Norac, Inc., Azusa, Cal.), 1.80 kg, was added. The mixture was blended for approx. 30 min. until smooth, and 0.225 kg TS-610 silica (a filler) was added, and the mixture was blended for approx. 30 min until smooth. At all times, the part (b) composition must be maintained at less than 30° C. The final product was packed into nylon cartridges for use in meter mix equipment.

The viscosity of the part (b) was 20,000-45,000 cP measured in a Brookfield viscometer at 20 rpm.

### Mixing

Parts (a) and (b) were mixed with a MIXPAC® nozzle set to a 10:1 mixture of parts (a) and (b). After mixing, the time to cure is approximately 110 to 130 minutes. Coupons were bonded 1″ by 0.5″, 30 mil bondline, and no surface preparation, and had a composite peel ply substrate shear strength of 1600 to 1800 psi.

What is claimed is:

1. An adhesive composition comprising:
(a) a first part comprising:
(i) a (meth)acrylic component;
(ii) an amine catalyst;
(iii) an optional second catalyst;
(iv) a reactive acid component; and
(v) a free-radical inhibitor;
and
(b) a second part comprising:
(i) a resin component comprising epoxy groups;
(ii) a peroxide; and
(iii) a basic metal compound;
wherein the first and second parts are each of a viscosity to render them pumpable, and when mixed, the first and second parts achieve a viscosity such that the mixed adhesive composition does not sag, drip, or migrate within the open time of the mixture of the first and second parts.

2. The composition of claim 1, wherein the acrylic component is selected from the group consisting of methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate, and combinations thereof.

3. The composition of claim 1, wherein the (meth)acrylic component is methyl methacrylate.

4. The composition of claim 1, wherein the amine is selected from the group consisting of 1,8-diazabicyclo(5.4.0)undec-7-ene, 1,4-diazabicyclo(2.2.2)octane, triethylamine, tetramethylguanidine, dimethyl-p-toluidine, dimethyl aniline, dihydroxyethyl aniline, dihydroxy ethyl p-toluidine, dimethyl-o-toluidine, dimethyl aniline, and benzoyl-thiourea, a trialkyl amine, tributyl amine, dihydro pyridine, phenyl dihydro pyridine, dihydropyridine derivatives, aldehyde condensation products of alkyl, aromatic, heterocyclic amines, and combinations thereof.

5. The composition of claim 1, wherein the amine is present in an amount sufficient to catalyze the cure of the adhesive.

6. The composition of claim 1, wherein the optional second catalyst is selected from the group consisting of pyridine N-oxide, quinoline, 8-hydroxyquinoline, benzyltrimethylammonium chloride, barium hydroxide, and combinations thereof.

7. The composition of claim 1, wherein the reactive acid component is sulphonic acid or a sulphonic acid derivative.

8. The composition of claim 1, wherein the reactive acid component is selected from the group consisting of phosphoric acid, phosphoric acid derivative, and a phosphate ester.

9. The composition of claim 1, wherein the reactive acid component is a phosphate ester comprising a compound of the formula: 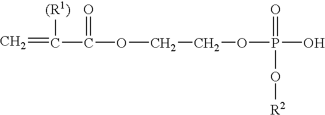
wherein R¹ is H or CH₃, and R² is H or:

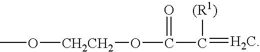

10. The composition of claim 1, wherein the reactive acid component is hydroxyl ethyl methacrylate phosphate ester.

11. The composition of claim 1, wherein the reactive acid component forms a gel or complex on mixing with the resin containing epoxy groups.

12. The composition of claim 1, wherein the free radical inhibitor is selected from the group consisting of quinones, hydroquinones, hydroxylamines, nitroxyls, phenols, amines, amities, quinolines, phenothiazines, and combinations thereof.

13. The composition of claim 1, wherein the free radical inhibitor is selected from the group consisting of hydroquinone, tertiary butylhydroquinone, phenothiazine, hydroxyethylhydroquinone, N-alkyl substituted p-phenylenediamines, and combinations thereof.

14. The composition of claim 1, wherein the free-radical inhibitor is present in an amount sufficient to prevent precurative reaction of the first part.

15. The composition of claim 1, wherein the resin is selected from the group consisting of cycloaliphatic epoxides, epoxy novolac resins, bisphenol-A epoxy resins, bisphenol-F epoxy resins, bisphenol-A epichlorohydrin based epoxy resin, alkyl epoxides, limonene dioxide, polyfunctional epoxides, and combinations thereof.

16. The composition of claim 1, wherein the resin is a liquid bisphenol A epichlorohydrin epoxy resin.

17. The composition of claim 1, wherein the peroxide is selected from the group consisting of cumene hydroperoxide, methyl ethyl ketone peroxide, benzoyl peroxide, acetyl peroxide, 2,5-dimethylhexane-2,5-dihydroperoxide, tert-butyl peroxybenzoate, di-tert-butyl perphthalate, dicumyl peroxide, 2,5-dimethyl-2,5-bis(tert-butylperoxide)hexane, 2,5-dimethyl-2,5-bis(tert-butylperoxy)hexyne, bix(tert-butylperoxyisopropyl)benzene, di-tert-butyl peroxide, 1,1-di(tert-amylperoxy)-cyclohexane, 1,1-di-(tert-butylperoxy)-3,3,5-trimethylcyclohexane, 1,1-di-(tert-butylperoxy)-cyclohexane, 2-di-(tert-butylperoxy)butane, n-butyl-4,4-di(tert-butylperoxy)valerate, ethyl-3,3-di-(tert-amylperoxy)butyrate, ethyl-3,3-di(tert-butylperoxy)-butyrate, t-butyl peroxy-neodecanoate, di-(4-5-butyl-cyclohexyl)-peroxydicar-bonate, lauryl peroxyde, 2,5-dimethyl-2,5-bis(2-ethyl-hexanoyl peroxy) hexane, t-amyl peroxy-2-ethylhexanoate, and 2,2′-azobis(2-methyl-propionitrile), 2,2′-azobis(2,4-methlbutanenitrile), and combinations thereof.

18. The composition of claim 1, wherein the basic metal compound forms a complex with the reactive acid component and is substantially non-reactive with the peroxide.

19. The composition of claim 1, wherein the basic metal compound is selected from the group consisting of zinc complexes, bismuth complexes, and combinations thereof.

20. The composition of claim 1, wherein the metal compound is bismuth subsalicylate.

21. A method of preparing a sag-resistant adhesive composition comprising:
(a) a first part comprising:
(i) a (meth)acrylic component;
(ii) an amine catalyst;
(iii) an optional second catalyst;
(iv) a reactive acid component; and
(v) a free-radical inhibitor;
and
(b) a second part comprising:
(i) a resin component comprising epoxy groups;
(ii) a peroxide; and
(iii) a basic metal compound;
wherein the first and second parts are each of a viscosity to render them pumpable, and when mixed, the first and second parts achieve a viscosity such that the mixed adhesive composition does not sag, drip, or migrate within the open time of the mixture of the first and second parts.

22. The method of claim 21, wherein the first part and second are mixed in a ratio of 3 to 50 parts part (a) to one part part (b) by volume.

23. The method of claim 21, wherein the first part and second are mixed in a ratio of 5 to 15 parts part (a) to one part part (b) by volume.

24. A method of bonding a first surface to a second surface, comprising:
providing a two part composition comprising:
(a) a first part comprising:
(i) a (meth)acrylic component;
(ii) an amine catalyst;
(iii) an optional second catalyst;
(iv) a reactive acid component; and
(v) a free-radical inhibitor;
and
(b) a second part comprising:
(i) a resin component comprising epoxy groups;
(ii) a peroxide; and
(iii) a basic metal compound;
wherein the first and second parts are each of a viscosity to render them pumpable, mixing the first and second parts, applying the mixed two part composition onto at least one surface, wherein the mixed two part composition achieves a viscosity such that the mixed two part composition does not sag, drip, or migrate within the open time of the mixture of the first and second parts, and joining a second surface to the first surface, and allowing the composition to cure.
